(19) United States
(12) Patent Application Publication
(10) Pub. No.: US 2012/0098728 A1
(43) Pub. Date: Apr. 26, 2012

(54) ANTENNA MODULE

(75) Inventors: Noboru KATO, Nagaokakyo-shi (JP); Katsumi TANIGUCHI, Nagaokakyo-shi (JP); Nobuo IKEMOTO, Nagaokakyo-shi (JP); Hiromi MURAYAMA, Nagaokakyo-shi (JP)

(73) Assignee: MURATA MANUFACTURING CO., LTD., Nagaokakyo-shi (JP)

(21) Appl. No.: 13/339,393

(22) Filed: Dec. 29, 2011

Related U.S. Application Data
(63) Continuation of application No. PCT/JP2010/061232, filed on Jul. 1, 2010.

(30) Foreign Application Priority Data
Jul. 3, 2009 (JP) 2009-158334

(51) Int. Cl. H04B 5/00; H01Q 1/50

(52) U.S. Cl. 343/856; 343/867

(57) ABSTRACT

An antenna includes a flexible sheet, a first coil electrode located on a first main surface of the flexible sheet and a second coil electrode located on a second main surface of the flexible sheet. A base film is arranged on the first main surface of the flexible sheet and a wireless communication IC is mounted on the base film. Two input/output terminals of the wireless communication IC are connected to coupling electrodes. A first coupling electrode opposes one end portion of the first coil electrode with the base film disposed therebetween. A second coupling electrode opposes one end of the second coil electrode with the base film, a central electrode and the flexible sheet disposed therebetween.

### BACKGROUND OF THE INVENTION

1. Field of the Invention

The present invention relates to antenna modules for communication in which electromagnetic field coupling is used, such as RFID communication.

2. Description of the Related Art

Currently, short-range communication systems, in which a variety of non-contact ICs are employed, are widely used in a variety of fields. This type of communication system is formed of a non-contact IC card, which is equipped with, for example, a wireless communication IC, and a card reader, and communication is performed by bringing the non-contact IC card and the card reader within a predetermined distance from each other. An antenna is needed to perform communication and the resonant frequency of the antenna is set on the basis of the frequency of a communication signal. Examples of such an antenna are described in Japanese Unexamined Patent Application Publication No. 2001-84463, Japanese Unexamined Patent Application Publication No. 10-334203 and Japanese Unexamined Patent Application Publication No. 2000-295024 and these antennas include a coil electrode, which is wound in a substantially planar shape, and a structure that causes a capacitance to be generated, which, along with the inductance of the coil electrode, is used to set the resonant frequency.

For example, in Japanese Unexamined Patent Application Publication No. 2001-84463, a coil electrode is provided that is wound in a predetermined manner on each of a front surface side and a back surface side of an insulating sheet. These coil electrodes are arranged so as to oppose each other, whereby a desired capacitance is generated. In this case, a large capacitance is obtained by making the width of the coil electrodes large.

In addition, in Japanese Unexamined Patent Application Publication No. 2001-84463, a structure is described in which a coil electrode and one opposing electrode of a capacitor are formed on the front surface side of the insulating sheet and the other opposing electrode of the capacitor is formed on the back surface side of the insulating sheet. In this structure, a conductive through hole is mechanically formed through the insulating sheet in order to connect the back-surface-side opposing electrode and a front-surface-side circuit pattern.

Furthermore, in Japanese Unexamined Patent Application Publication No. 10-334203, a coil electrode is formed on the front surface side of an insulating sheet and a coil electrode and an electrostatic-capacitance-adjusting pattern, which is for causing a capacitance to be generated, are formed on the back surface side of the insulating sheet. Then, the capacitance is adjusted by adjusting the shape (line length) of the electrostatic-capacitance-adjusting pattern.

Furthermore, in Japanese Unexamined Patent Application Publication No. 2000-295024, coil electrodes formed on both main surfaces of an insulating sheet are connected to each other via a through hole.

However, with the structure of Japanese Unexamined Patent Application Publication No. 2001-84463 described above, since the coil electrode is formed to have a small number of turns and a large width, although the capacitance is large, the inductance is very small. Consequently, only a weak magnetic field can be radiated by the antenna and the distance over which communication can be performed is short. This is not suitable for data communication in which a certain signal level is required.

Furthermore, in the structure of the related art of Japanese Unexamined Patent Application Publication No. 2001-84463 described above, since the insulating sheet is subjected to mechanical punching in order to physically bring the front-surface-side electrode pattern and the back-surface-side electrode pattern into conductive contact with each other, the manufacturing process is complex.

In addition, in the structure of Japanese Unexamined Patent Application Publication No. 10-334203 described above, the back-surface-side electrostatic-capacitance-adjusting pattern is formed so as to be wound in the same direction as the front-surface-side coil electrode, when viewed in plan, that is, along the direction of the magnetic field at the surface of the antenna. Therefore, the back-surface-side electrostatic-capacitance-adjusting pattern does not contribute to the inductance of the antenna and the inductance of the antenna only depends on the pattern of the front-surface-side coil electrode. Consequently, an increase in the size of the structure due to, for example, the number of turns of the front-surface-side coil electrode being increased in order to increase the impedance so as to increase the strength of the radiated magnetic field, is unavoidable.

In addition, in the structure of Japanese Unexamined Patent Application Publication No. 2000-295024, a through hole that connects the coil electrodes formed on the two main surfaces of the insulating sheet needs to be provided in the insulating sheet and similarly to Japanese Unexamined Patent Application Publication No. 2001-84463, the manufacturing process is complicated.

In addition, in the case where an antenna module is formed by connecting a wireless communication IC such as an RFID chip to this type of antenna, the resonant frequency of the antenna is affected by the capacitance of the wireless communication IC. In this case, if the capacitances of such wireless communication ICs vary, then the resonant frequencies of the antennas will also vary in response to this variation.

### SUMMARY OF THE INVENTION

In view of the various issues described above, preferred embodiments of the present invention provide an antenna module with which a predetermined magnetic field strength is obtained and that is simple and compact, while still being able to prevent variations in the values of wireless communication IC devices and achieve excellent communication characteristics.

According to a preferred embodiment of the present invention, an antenna module includes a wireless communication device and an antenna pattern. The wireless communication device includes a first input/output terminal and a second input/output terminal. The antenna pattern includes a first coil electrode that includes a first end portion connected in a high frequency manner to the first input/output terminal and a second coil electrode that includes a second end portion that is connected in a high frequency manner to the second input/output terminal. The first coil electrode and the second coil electrode are formed and arranged such that a predetermined coupling capacitance is obtained. The coupling capacitance of this antenna pattern is preferably larger than the capacitance of the wireless communication device.

In this configuration, the combined capacitance of the antenna module is a capacitance that is equal to the sum of the coupling capacitance generated by the antenna pattern and the capacitance of the wireless communication device connected in parallel with each other. Therefore, by setting the coupling capacitance of the antenna pattern to be larger than the capacitance of the wireless communication device, the combined capacitance of the antenna module will be weakly dependent on the capacitance of the wireless communication device and instead be more dependent on the coupling capacitance generated by the antenna pattern. Thus, provided that the accuracy with which the antenna pattern is formed is high, variations in the characteristics of the antenna module will be small.

In addition, the antenna module according to a preferred embodiment of the present invention can include a first capacitor electrode that is connected to the first input/output terminal and a second capacitor electrode that is connected to the second input/output terminal. In addition, this antenna module can include a third capacitor electrode that is defined by the first end portion of the first coil electrode and is capacitively coupled with the first capacitor electrode and a fourth capacitor electrode that is defined by the second end portion of the second coil electrode and is capacitively coupled with the second capacitor electrode. It is preferable that the coupling capacitance defined by the first capacitor electrode and the third capacitor electrode and the coupling capacitance defined by the second capacitor electrode and the fourth capacitor electrode be both larger than the capacitance of the wireless communication device.

With this configuration, a specific configuration is described in which the wireless communication device and the antenna pattern are connected to each other in a high-frequency manner. In the case in which connection is made via capacitors in this way, provided that the capacitance of capacitors connected in series between the wireless communication device and the antenna pattern is made large, the series circuit combined capacitance of the capacitors and the wireless communication device depends on the capacitance of the wireless communication device. Therefore, it can be accordingly ensured that the characteristics of the antenna module will depend on the coupling capacitance of the antenna pattern, by inserting such capacitors.

In addition, in the antenna module according to a preferred embodiment of the present invention, the first capacitor electrode and the second capacitor electrode may be disposed on the same surface of a first insulating substrate and the antenna pattern may be disposed on a second insulating substrate. The first insulating substrate may be arranged on the second insulating substrate such that the surface thereof on the opposite side to the surface thereof on which the first capacitor electrode and the second capacitor electrode are disposed is in contact with the second insulating substrate.

With this configuration, a more specific structure is described in which capacitors are inserted between the two ends of the above-described antenna pattern and the two ends of the wireless communication device, whereby the antenna pattern and the wireless communication device are connected in a high frequency manner.

In addition, in the antenna module according to a preferred embodiment of the present invention, a first connection electrode pattern that connects the first capacitor electrode and the first input/output terminal and a second connection electrode pattern that connects the second capacitor electrode and the second input/output terminal may be disposed on the surface of the first insulating substrate on which the first capacitor electrode and the second capacitor electrode are provided.

With this configuration, a specific configuration to connect the above-described wireless communication device and each of the capacitors is described.

Furthermore, in the antenna module according to a preferred embodiment of the present invention, the first coil electrode and the third capacitor electrode may be disposed on the surface of the second insulating substrate that is on the first insulating substrate side thereof. The second coil electrode and the fourth capacitor electrode may be disposed on the surface of the second insulating substrate that is on the side opposite to the first insulating substrate side thereof.

With this configuration, a specific structure of the above-described antenna pattern and each of the capacitors is described.

In addition, in the antenna module according to a preferred embodiment of the present invention, a central electrode, which is at least partially superposed with the second capacitor electrode and the fourth capacitor electrode in plan view may be disposed on the surface of the second insulating substrate on which the first coil electrode and the third capacitor electrode are provided.

With this configuration, another example of a configuration for a capacitor to be inserted between the above-described antenna pattern and the wireless communication device is described.

In addition, in the antenna module according to a preferred embodiment of the present invention, the first input/output terminal and the first end portion of the first coil electrode may be connected by a wiring electrode pattern. In addition, this antenna module may include a fifth capacitor electrode that is connected to the second input/output terminal and a sixth capacitor electrode that is defined by the second end portion of the second coil electrode and is capacitively coupled with the second capacitor electrode. It is preferable that the coupling capacitance defined by the fifth capacitor electrode and the sixth capacitor electrode be larger than the capacitance of the wireless communication device.

With this configuration, a specific configuration is described for a case in which, as a configuration to connect the above-described antenna pattern and the wireless communication device, first ends are directly connected to each other and second ends are connected to each other via a capacitor. With this configuration, the number of constituent elements of the antenna module is reduced and therefore a simpler structure is realized.

In addition, in the antenna module according to a preferred embodiment of the present invention, the first coil electrode and the second coil electrode preferably have coil shapes such that currents flow through the coil electrodes in the same direction.

With this configuration, the magnetic field generated by the antenna of the antenna module can be made stronger even though the antenna has a simple structure.

According to various preferred embodiments of the present invention, a simple and compact antenna module in which the effects of variations in the capacitance of a wireless communication IC are prevented, that generates a stronger magnetic field than in the related art and that has excellent communication characteristics can be realized.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an exploded perspective view illustrating the configuration of an antenna module 100 according to a first preferred embodiment of the present invention.

FIGS. 2A and 2B illustrate the antenna module 100 according to the first preferred embodiment of the present invention as an equivalent circuit viewed from the side and an approximate simplified equivalent circuit.

FIG. 3 is an exploded perspective view illustrating the configuration of an antenna module 100A according to a second preferred embodiment of the present invention.

FIGS. 4A and 4B illustrate the antenna module 100A according to the second preferred embodiment of the present invention as an equivalent circuit viewed from the side and an approximate simplified equivalent circuit.

FIGS. 5A and 5B are plan views illustrating another example of formation of a first coil electrode and a second coil electrode.

FIGS. 6A and 6B illustrate the configuration of an electromagnetic coupling module 90.

### DETAILED DESCRIPTION OF THE PREFERRED EMBODIMENTS

An antenna module according to a first preferred embodiment of the present invention will now be described with reference to the drawings.

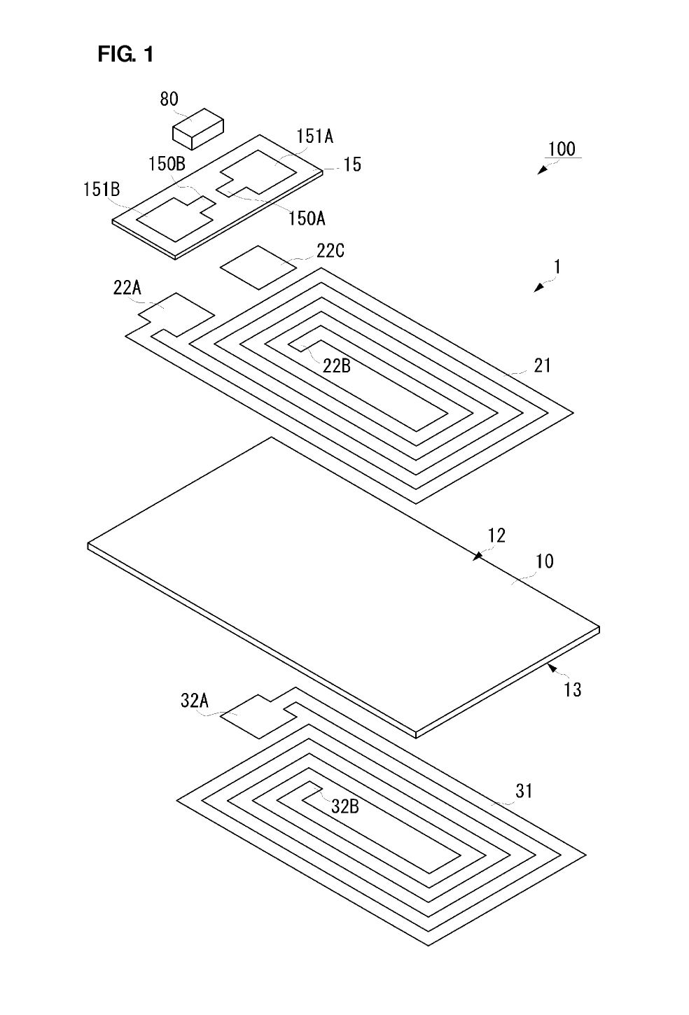

FIG. 1 is an exploded perspective view illustrating the configuration of an antenna module 100 according to this preferred embodiment of the present invention.

The antenna module 100 includes an antenna 1, a wireless communication IC 80 and a base film 15 (corresponding to a “first insulating substrate” according to a preferred embodiment of the present invention).

The antenna 1 preferably includes a first coil electrode 21, which preferably has a coil shape on a first main surface 12 of an insulating flexible sheet 10 (corresponding to a “second insulating substrate” according to a preferred embodiment of the present invention) and a second coil electrode 31, which preferably has a coil shape on a second main surface 13 of the insulating flexible sheet 10. The first coil electrode has a shape in which it is sequentially wound toward the inside in the counterclockwise direction from an outermost peripheral end portion 22A to an innermost peripheral end portion 22B, when viewed from the first main surface 12 side. The second coil electrode 31 has a shape in which it is sequentially wound toward the outside in the clockwise direction from an innermost peripheral end portion 32B to an outermost peripheral end portion 32A, when viewed from the second main surface 13 side.

The outermost peripheral end portion 22A of the first coil electrode 21 preferably has a substantially square shape having a width that is larger than that of the wound line-shaped electrode portion. This end portion corresponds to a “third capacitor electrode” according to a preferred embodiment of the present invention. The outermost peripheral end portion 32A of the second coil electrode 31 also has a substantially square shape having a width that is larger than that of the wound line-shaped electrode portion. This end portion corresponds to a “fourth capacitor electrode” according to a preferred embodiment of the present invention. In addition, the innermost peripheral end portion 22B of the first coil electrode 21 preferably has the same width as the wound line-shaped electrode portion. The innermost peripheral end portion 32B of the second coil electrode 31 has the same width as the wound line-shaped electrode portion.

In the configuration of this preferred embodiment, as described above, by forming the first coil electrode 21 and the second coil electrode 31 such that the coil electrodes are wound in opposite directions when viewed from different directions, the innermost peripheral end portion 22B of the first coil electrode 21 and the innermost peripheral end portion 32B of the second coil electrode 31, which are wound in the same direction when viewed from the same direction, are arranged to oppose each other. Thus, the directions in which currents flow through the first coil electrode 21 and the second coil electrode 31 are the same and the direction of the magnetic field generated by the first coil electrode 21 and the direction of the magnetic field generated by the second coil electrode 31 are the same. As a result, these magnetic fields act so as to be added together and the magnetic field of the antenna (magnetic field whose axis extends in a direction perpendicular or substantially perpendicular to the main surface) becomes stronger. In other words, the first coil electrode 21 and the second coil electrode function as a single coil whose winding direction does not change midway therealong, is continuous and has a greater number of turns. Here, a ring-shaped coil inductor is proportional to the square of the number of turns of the coil, and therefore if the number of turns is increased, the generated magnetic field becomes stronger by a corresponding amount. As a result, a much stronger magnetic field can be generated and the performance of an antenna using electromagnetic field coupling can be improved, compared with a configuration in which a ring-shaped coil electrode is substantially formed on only one surface of an insulating sheet as described in the examples of the related art. In this case, without carrying out mechanical connection processing such as forming holes in the flexible sheet 10, but by simply forming end portions of the first coil electrode 21 and the second coil electrode 31 so that they oppose each other, the first coil electrode 21 and the second coil electrode 31 can be connected in an alternating manner, and therefore a resonance type antenna having a simple structure can be formed by using a simple method.

In addition, in the configuration of this preferred embodiment, the first coil electrode 21 and the second coil electrode 31 are preferably arranged such that the wound line-shaped electrode portions oppose each other with the flexible sheet 10 therebetween over substantially the entire lengths thereof except for at some places such as at the outermost periphery, the innermost periphery and at bent portions. With this configuration, portions of the first coil electrode 21 and the second coil electrode 31 that oppose each other are capacitively coupled via the flexible sheet 10, which is an insulator, and function as capacitors. By arranging the electrodes so as to oppose each other over substantially the entire lengths of the line-shaped electrode portions thereof, a comparatively large capacitance can be obtained.

A substantially square-shaped central electrode 22C is disposed on the first main surface 12 of the flexible sheet 10 at a position that is separated from the outermost peripheral end portion 22A of the first coil electrode 21 by a predetermined distance. Specifically, the central electrode 22C is disposed so as to be superposed with the outermost peripheral end portion 32A of the second coil electrode 31 in plan view. The central electrode 22C preferably has substantially the same area as the outermost peripheral end portions 22A and 32A. In this way, a capacitor is defined by the outermost peripheral end portion 32A of the second coil electrode 31, the central electrode 22C and the flexible sheet 10, the capacitor having a large opposing area and a comparatively large capacitance.

The base film 15 is preferably a planar film made of an insulating material having a predetermined thickness. The base film 15 includes an area that encompasses the outermost peripheral end portion 22A of the first coil electrode 21 and the central electrode 22C and in which the wireless communication IC 80 can be mounted.

A coupling electrode 151A (corresponding to a “second capacitor electrode” according to a preferred embodiment of the present invention) and a coupling electrode 151B (corresponding to a “first capacitor electrode” according to a preferred embodiment of the present invention) are provided on the base film 15. The coupling electrodes 151A and 151B are electrode patterns that are substantially square in plan view, similarly to the outermost peripheral end portion 22A of the first coil electrode 21 and the central electrode 22C. The coupling electrodes 151A and 151B are arranged with a gap therebetween that is preferably the same as the gap between the outermost peripheral end portion 22A of the first coil electrode 21 and the central electrode 22C.

In addition, IC connection electrodes 150A and 150B are located on the base film 15. One end of the IC connection electrode 150A is connected to the coupling electrode 151A and the other end of the IC connection electrode 150A defines one mounting land (corresponding to a “second input/output terminal” according to a preferred embodiment of the present invention) of the wireless communication IC 80. One end of the IC connection electrode 150B is connected to the coupling electrode 151B and the other end of the IC connection electrode 150B defines the other mounting land (corresponding to a “first input/output terminal” according to a preferred embodiment of the present invention) of the wireless communication IC 80. The wireless communication IC 80 is mounted on these mounting lands.

The base film 15 is mounted on the first main surface 12 of the flexible sheet 10 with an adhesive sheet or the like such that the lower surface thereof is in contact with the flexible sheet 10. At this time, the base film 15 is mounted such that the coupling electrode 151A opposes the central electrode 22C and the coupling electrode 151B opposes the outermost peripheral end portion 22A of the first coil electrode 21. With this structure, a capacitor is defined by the coupling electrode 151A, the central electrode 22C and the base film 15, the capacitor having a large opposing area and a comparatively large capacitance. In addition, a capacitor is also defined by the coupling electrode 151B, the outermost peripheral end portion 22A and the base film 15, the capacitor having a large opposing area and a comparatively large capacitance.

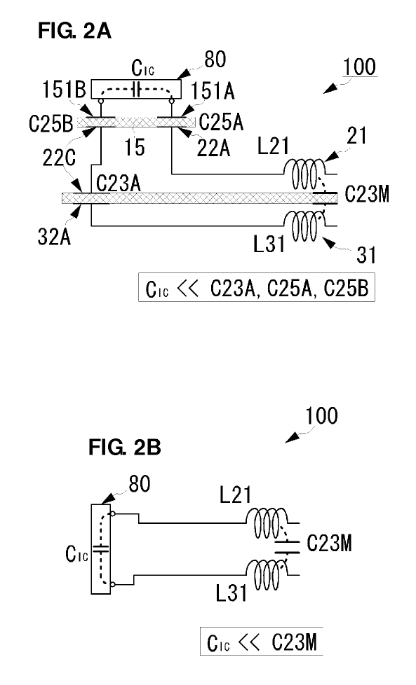

With this configuration, the antenna module 100 of this preferred embodiment has the circuit configuration illustrated in FIGS. 2A and 2B. FIG. 2A illustrates the antenna module 100 of this preferred embodiment as an equivalent circuit viewed from the side and FIG. 2B is an approximate equivalent simplified circuit.

As illustrated in FIGS. 2A and 2B, the antenna module 100 can be regarded as an equivalent circuit in which a capacitor (capacitance C25A) defined by the outermost peripheral end portion 22A and the coupling electrode 151A, the wireless communication IC 80, a capacitor (capacitance C25B) defined by the coupling electrode 151B and the central electrode 22C and a capacitor (capacitance C23A) defined by the central electrode 22C and the outermost peripheral end portion 32A are connected in series with each other between the outermost peripheral end portion 22A of an inductor (inductance L21) defined by the first coil electrode 21 and the outermost peripheral end portion 32A of an inductor (inductance L31) defined by the second coil electrode 31.

Here, the wireless communication IC 80 has a very small capacitance C_{IC}, which is the capacitance of the IC itself.

Therefore, in the circuit configuration, a capacitor (capacitance C25A) defined by the outermost peripheral end portion 22A and the coupling electrode 151A, a capacitor (capacitance C_{IC}) that is the wireless communication IC 80 itself, a capacitor (capacitance C25B) defined by the coupling electrode 151B and the central electrode 22C and a capacitor (capacitance C23A) defined by the central electrode 22C and the outermost peripheral end portion 32A are connected in series with one another.

In this circuit, the capacitor that is the wireless communication IC 80 (capacitance C_{IC}) is sufficiently smaller than the other capacitors (capacitances C25A, C25B and C23A). For example, in a specific example, C_{IC} is approximately 8 pF and C25A, C25B and C23A are set to approximately 50 pF.

Thus, this circuit is a circuit in which capacitors are connected in series with each other and the capacitor that is the wireless communication IC 80 (capacitance C_{IC}) is sufficiently smaller than the other capacitors (capacitances C25A, C25B and C23A). In other words, C_{IC}<<C25A, C25B and C23A. Therefore, the combined capacitance is strongly affected by the capacitor that is the wireless communication IC 80 itself (capacitance C_{IC}), which has a capacitance smaller than the other capacitances, and is a value close to the capacitance C_{IC}.

In this case, the combined capacitance of the entire antenna module 100, as illustrated in FIG. 2B, is a capacitance that is the parallel sum of the capacitor that is the wireless communication IC 80 (capacitance C_{IC}) and a capacitor defined by the first coil electrode 21 and the second coil electrode 31 being capacitively coupled with each other (capacitance C23M).

As described above, the capacitor defined by the first coil electrode 21 and the second coil electrode 31 (capacitance C23M) being capacitively coupled with each other is preferably set so as to be large. Specifically the capacitor is preferably set to be on the order of about 200 pF, for example. Thus, C_{IC}<<C23M.

Therefore, the combined capacitance, which affects the resonance characteristics of the antenna module 100, is a value that is approximately the same as that of the capacitor defined by the first coil electrode 21 and the second coil electrode 31 being capacitively coupled with each other (capacitance C23M).

Therefore, even if the capacitance C_{IC} varies in the process of manufacturing the wireless communication IC 80, resonance characteristics that are not affected and are stable can be obtained. Thus, antenna modules that have excellent communication characteristics can be stably manufactured.

For example, currently, the capacitance C_{IC} of the wireless communication IC 80 will vary on the order of about ±3%, but manufacturing can be carried out such that the capacitance C23M of the capacitor defined by the first coil electrode 21 and the second coil electrode 31 being capacitively coupled with each other will vary on the order of about ±1.0% to about ±2.0%, for example.

As described above, in the configuration of this application, the resonance characteristics of the antenna strongly depend on the capacitance C23M of the capacitor defined by the first coil electrode 21 and the second coil electrode 31 being capacitively coupled with each other and the effect of the capacitance C_{IC} of the wireless communication IC 80 on the resonance characteristics of the antenna is prevented. Therefore, the resonance characteristics of the antenna can be improved by making the error of the capacitance C23M of the capacitor defined by the first coil electrode 21 and the second coil electrode 31 being capacitively coupled with each other low, for example, on the order of about ±1.0% to about 2.0%.

In addition, at this time, such highly accurate characteristics are obtained by simply appropriately setting the opposing area of the two coil-shaped electrodes without the need for a complex structure. Therefore, an improvement in the performance of the antenna module can be realized with a structure that is simple and easy to design.

In the above description, an example was described in which the central electrode 22C is provided, but the central electrode 22C can instead be omitted. Thus, an antenna module that has a simpler structure can be provided.

Next, an antenna module according to a second preferred embodiment of the present invention will be described with reference to the drawings.

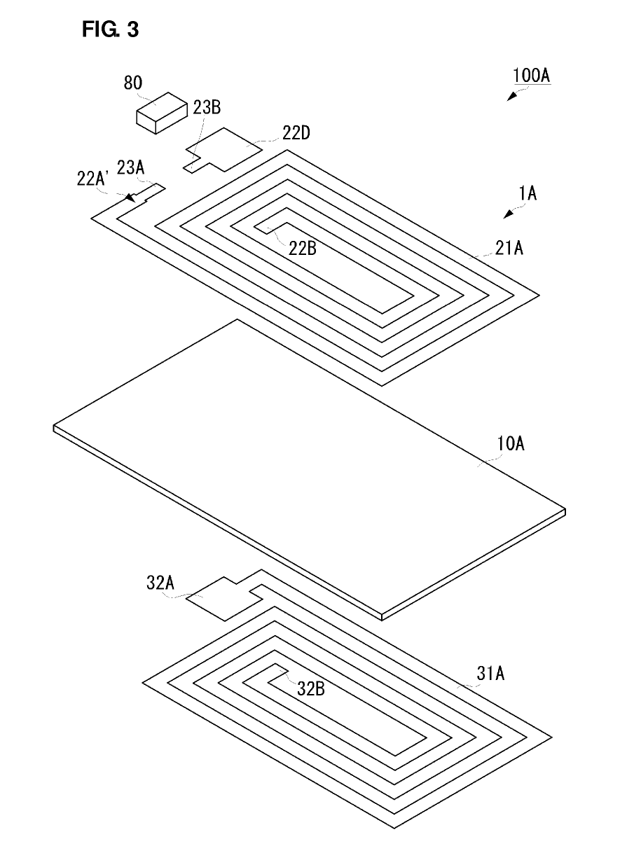

FIG. 3 is an exploded perspective view illustrating the configuration of an antenna module 100A according to this preferred embodiment of the present invention. As illustrated in FIG. 3, in the antenna module 100A of this preferred embodiment of the present invention, in contrast to the antenna module 100 of the first preferred embodiment, the wireless communication IC 80 is directly mounted on a flexible sheet 10A without using the base film 15. Therefore, only points that are different from the first preferred embodiment will be specifically described and description of points of the configuration that are the same will be omitted.

An outermost peripheral end portion 22A′ of a first coil electrode 21A located on a first main surface of the flexible sheet 10A is provided with the same width as the line-shaped electrode portion. An IC connection electrode 23A located on the same first main surface is connected to the outermost peripheral end portion 22A′.

In addition, a substantially square-shaped coupling electrode 22D (corresponding to a “fifth input/output terminal” according to a preferred embodiment of the present invention) is arranged at a position spaced apart from the outermost peripheral end portion 22A′ of the first coil electrode 21A by a predetermined distance on the first main surface of the flexible sheet 10A. Specifically, the coupling electrode 22D is arranged so as to be superposed with an outermost peripheral end portion 32A (corresponding to a “sixth capacitor electrode” according to a preferred embodiment of the present invention) of a second coil electrode 31A in plan view. The coupling electrode 22D preferably has substantially the same area as the outermost peripheral end portion 32A. In this way, a capacitor is defined by the outermost peripheral end portion 32A of the second coil electrode 31A, the coupling electrode 22D and the flexible sheet 10A, the capacitor having a large opposing area and a comparatively large capacitance.

An IC connection electrode 23B located on the same first main surface is connected to the coupling electrode 22D.

The wireless communication IC 80 is mounted on the IC connection electrodes 23A and 23B.

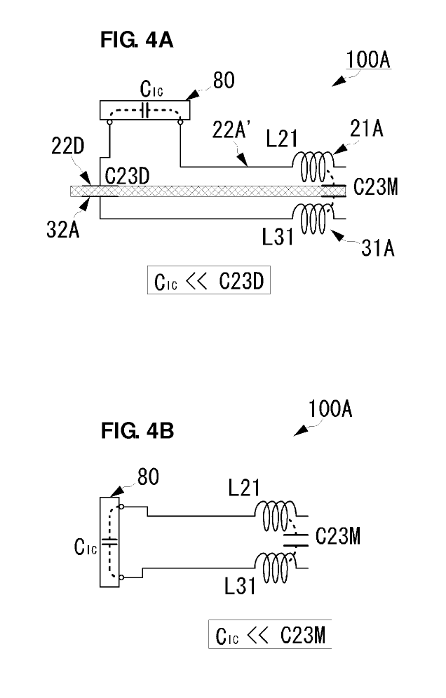

With this configuration, the antenna module 100A of this preferred embodiment has the circuit configuration illustrated in FIGS. 4A and 4B. FIG. 4A illustrates the antenna module 100A of this preferred embodiment as an equivalent circuit viewed from the side and FIG. 4B is an approximate equivalent simplified circuit.

As illustrated in FIGS. 4A and 4B, the antenna module 100A can be regarded as an equivalent circuit in which the wireless communication IC 80 and a capacitor (capacitance C23D) defined by the coupling electrode 22D and the outermost peripheral end portion 32A are connected in series between the outermost peripheral end portion 22A′ of an inductor (inductance L21) defined by the first coil electrode 21A and the outermost peripheral end portion 32A of an inductor (inductance L31) defined by the second coil electrode 31A.

Here, the wireless communication IC 80 has a very small capacitance C_{IC}, which is the capacitance of the IC itself.

Therefore, in this circuit configuration, a capacitor (capacitance C_{IC}) that is the wireless communication IC 80 itself and a capacitor (capacitances C23D) defined by the coupling electrode 22D and the outermost peripheral end portion 32A are connected in series with each other.

In this circuit, the capacitor that is the wireless communication IC 80 (capacitance C_{IC}) is sufficiently smaller than the capacitor (capacitance C23D) defined by the coupling electrode 22D and the outermost peripheral end portion 32A. For example, in a specific example, C_{IC} is approximately 8 pF and C23D is set to approximately 50 pF.

Thus, in this circuit, which is a circuit in which capacitors are connected in series with each other, the capacitor that is the wireless communication IC 80 (capacitance C_{IC}) is sufficiently smaller than the capacitor (capacitance C23D) defined by the coupling electrode 22D and the outermost peripheral end portion 32A. That is, C_{IC}<<C23D. Therefore, the combined capacitance is strongly affected by the capacitor that is the wireless communication IC 80 itself (capacitance C_{IC}) and is a value close to the capacitance C_{IC}.

The combined capacitance of the entire antenna module 100A, as illustrated in FIG. 4B, is a capacitance that is the parallel sum of the capacitor that is the wireless communication IC 80 (capacitance C_{IC}) and a capacitor defined by the first coil electrode 21A and the second coil electrode 31A being capacitively coupled with each other (capacitance C23M). As described above, the capacitor defined by the first coil electrode 21A and the second coil electrode 31A being capacitively coupled with each other (capacitance C23M) is set so as to be large. Specifically the capacitor is set to be on the order of about 200 pF, for example. Thus, C_{IC}<<C23M.

Therefore, the combined capacitance, which affects the resonance characteristics of the antenna module 100A, is a value that is approximately the same as that of the capacitor defined by the first coil electrode 21A and the second coil electrode 31A being capacitively coupled with each other (capacitance C23M). Thus, similarly to the first preferred embodiment, even if the capacitance C_{IC} varies in the process of manufacturing the wireless communication IC 80, resonance characteristics that are not affected and are stable can be obtained. Thus, antenna modules that have excellent communication characteristics can be stably manufactured.

In the above-described first preferred embodiment of the present invention, a case was described in which the wound line-shaped portions of the first coil electrode and the second coil electrode including a flexible sheet therebetween oppose each other over substantially the entire lengths thereof and in which the outermost peripheral end portions of the first coil electrode and the second coil electrode preferably have planar shapes whose widths are larger than those of the respective line-shaped electrode portions.

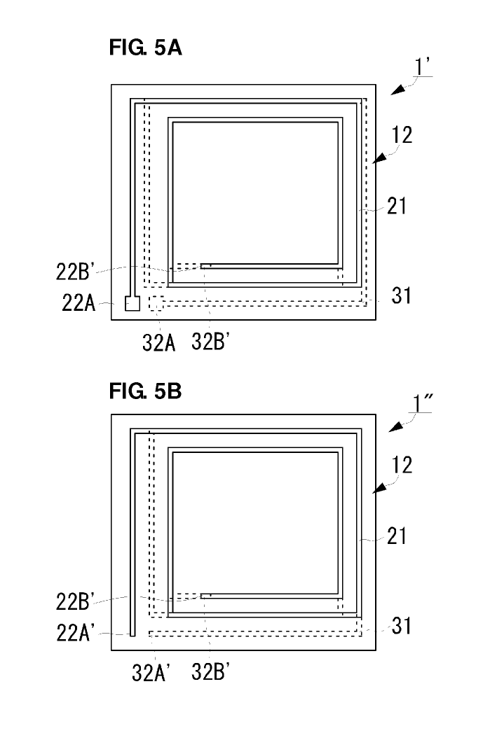

However, provided that the above-described predetermined inductances and capacitances are obtained, the structure illustrated in FIGS. 5A and 5B may be adopted. FIGS. 5A and 5B are plan views illustrating another example of formation of a first coil electrode and a second coil electrode. FIG. 5A illustrates a case in which the line-shaped electrode portions do not oppose each other in the vicinity of the outer peripheries of the first coil electrode 21 and the second coil electrode 31. FIG. 5B illustrates a case in which the outermost peripheral ends of the first coil electrode 21 and the second coil electrode 31 have the same width as the line-shaped electrode portions. The same operational effects as in each of the above-described preferred embodiments can also be obtained with these structures. These are examples of shapes of the first coil electrode and the second coil electrode, but other similar structures, which can be assumed from these structures and with which the capacitances defined in the above-described concept are obtained, may be applied to the configuration of various preferred embodiments of the present invention.

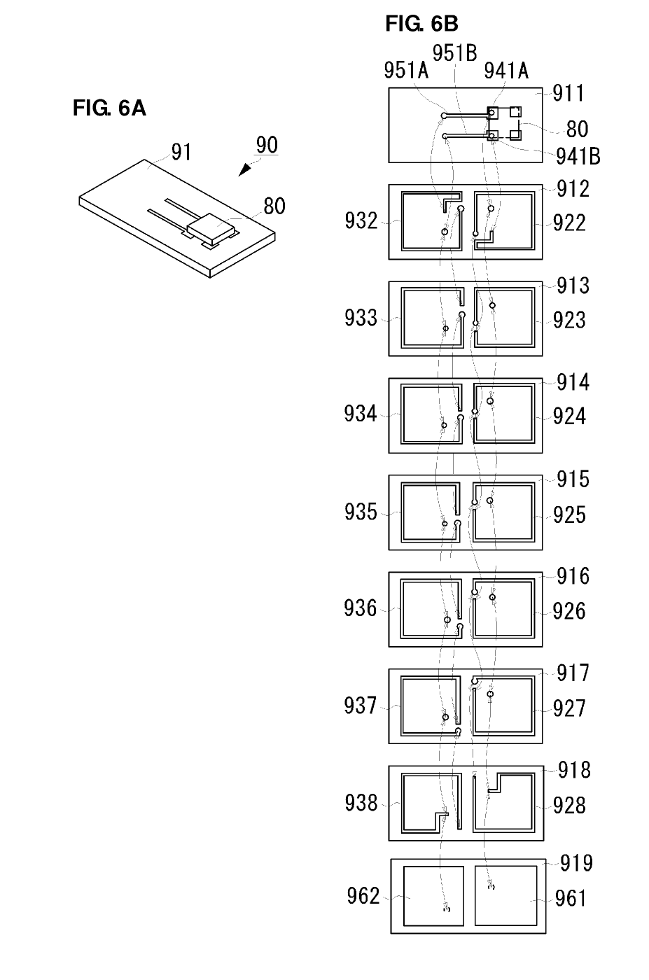

Furthermore, in the above descriptions, examples were described in which a wireless communication IC chip is preferably used by itself, but an electromagnetic coupling module such as that illustrated in FIGS. 6A and 6B may be used. FIGS. 6A and 6B illustrate the configuration of an electromagnetic coupling module 90, where FIG. 6A illustrates an external perspective view and FIG. 6B illustrates an exploded layered view.

The electromagnetic coupling module 90 includes a power-feeding substrate 91 and the wireless communication IC 80, which is mounted on the power-feeding substrate 91, as illustrated in FIGS. 6A and 6B. The power-feeding substrate 91 preferably is a multilayer circuit board including stacked dielectric layers on which electrode patterns are disposed on surfaces thereof. For example, as illustrated in FIG. 6B, a structure is adopted that is formed by stacking preferably nine dielectric layers 911 to 919 on top of one another. On the dielectric layer 911, which is the uppermost layer, mounting lands 941A and 941B for the wireless communication IC 80 are provided and respective surface electrode patterns 951A and 951B are disposed on the mounting lands 941A and 941B. On the second to eighth dielectric layers 912 to 918, respective first C-shaped pattern electrodes 922 to 928 and second C-shaped pattern electrodes 932 to 938 are provided.

The first C-shaped pattern electrodes 922 to 928 are electrically connected to one another by via holes and define a first coil whose axial direction is the stacking direction. The two ends of the first coil are respectively connected to the mounting lands 941A and 941B provided on the dielectric layer 911, which is the uppermost layer, through via holes. In addition, the second C-shaped pattern electrodes 932 to 938 are electrically connected to one another by via holes and define a second coil whose axial direction is the stacking direction. The two ends of the second coil are respectively connected to end portions of the surface electrode patterns 951A and 951B provided on the dielectric layer 911, which is the uppermost layer, through via holes.

Two outer connection electrodes 961 and 962 are provided on the dielectric layer 919, which is the lowermost layer. The two outer connection electrodes 961 and 962 are respectively connected to the first C-shaped pattern electrodes 922 to 928 and the second C-shaped pattern electrodes 932 to 938 via through holes. These two outer connection electrodes 961 and 962 play the same role as the mounting lands to connect the wireless communication IC to the outside, as described in each of the above-described preferred embodiments.

In the case in which the electromagnetic coupling module 90 is used, the value of each element of the antenna module may be set by using not only the capacitance of the wireless communication IC 80, but also by using the capacitance of the electromagnetic coupling module 90.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An antenna module comprising:
a wireless communication device including a first input/output terminal and a second input/output terminal; and
an antenna pattern that includes a first coil electrode including a first end portion that is connected in a high-frequency manner to the first input/output terminal and a second coil electrode including a second end portion that is connected in a high-frequency manner to the second input/output terminal, the first coil electrode and the second coil electrode being formed and arranged such that a predetermined coupling capacitance is obtained; wherein
the coupling capacitance of the antenna pattern is larger than a capacitance of the wireless communication device.

2. The antenna module according to claim 1, further comprising:
a first capacitor electrode that is connected to the first input/output terminal;
a second capacitor electrode that is connected to the second input/output terminal;
a third capacitor electrode that is defined by the first end portion of the first coil electrode and is capacitively coupled with the first capacitor electrode; and
a fourth capacitor electrode that is defined by the second end portion of the second coil electrode and is capacitively coupled with the second capacitor electrode; wherein
the coupling capacitance defined by the first capacitor electrode and the third capacitor electrode and the coupling capacitance defined by the second capacitor electrode and the fourth capacitor electrode are both larger than the capacitance of the wireless communication device.

3. The antenna module according to claim 2, wherein the first capacitor electrode and the second capacitor electrode are located on a same surface of a first insulating substrate,
the antenna pattern is located on a second insulating substrate, and
the first insulating substrate is arranged on the second insulating substrate such that a surface thereof on the opposite side to the surface thereof on which the first capacitor electrode and the second capacitor electrode are located is in contact with the second insulating substrate.

4. The antenna module according to claim 3, wherein a first connection electrode pattern that connects the first capacitor electrode and the first input/output terminal to each other and a second connection electrode pattern that connects the second capacitor electrode and the second input/output terminal to each other are located on the surface of the first insulating substrate on which the first capacitor electrode and the second capacitor electrode are located.

5. The antenna module according to claim 2, wherein the first coil electrode and the third capacitor electrode are located on the surface of the second insulating substrate that is on the first insulating substrate side of the second insulating substrate, and the second coil electrode and the fourth capacitor electrode are located on a surface of the second insulating substrate that is on the opposite side to the first insulating substrate side of the second insulating substrate.

6. The antenna module according to claim 5, wherein a central electrode, which is at least partially superposed with the second capacitor electrode and the fourth capacitor electrode in plan view is located on the surface of the second insulating substrate on which the first coil electrode and the third capacitor electrode are located.

7. The antenna module according to claim 1, wherein the first input/output terminal and the first end portion of the first coil electrode are connected by a wiring electrode pattern, the antenna module further comprises:
a fifth capacitor electrode that is connected to the second input/output terminal; and
a sixth capacitor electrode that is defined by the second end portion of the second coil electrode and is capacitively coupled with the second capacitor electrode; wherein
a coupling capacitance defined by the fifth capacitor electrode and the sixth capacitor electrode is larger than a capacitance of the wireless communication device.

8. The antenna module according to claim 1, wherein the first coil electrode and the second coil electrode have coil shapes such that currents flow through the coil electrodes in the same direction.
